(19) United States
(12) Patent Application Publication
(10) Pub. No.: US 2023/0289606 A1
(43) Pub. Date: Sep. 14, 2023

(54) QUALITY ASSURANCE METHOD FOR AN EXAMPLE-BASED SYSTEM

(71) Applicant: Siemens Mobility GmbH, München (DE)

(72) Inventor: Thomas Waschulzik, Freising (DE)

(21) Appl. No.: 18/029,171

(22) PCT Filed: Sep. 10, 2021
(86) PCT No.: PCT/EP2021/074882

§ 371 Date: Mar. 29, 2023

(30) Foreign Application Priority Data
Sep. 29, 2020 (DE) 10 2020 212 235.0

(51) Int. Cl. G06N 3/084

(52) U.S. Cl. CPC G06N 3/084

(57) ABSTRACT

A quality assurance method for an example-based system improves quality assurance by creating and training the example-based system based on collected examples forming an example set. The respective example in the example set includes an input value in an input space. A first example set including a plurality of examples and a second example set including a plurality of examples are collected. A first quality rating representing coverage of the input space by the examples in the first example set is determined based on distribution of the input values in the input space. A second quality rating representing coverage of the input space by the examples in the second example set is determined based on distribution of the input values in the input space. The first and second quality ratings are compared to one another. A computer program and a computer-readable storage medium are also provided.

The invention relates to a method for quality assurance of an example-based system.

Example-based systems, such as artificial neural networks, are known in principle. These are generally used in areas in which a direct algorithmic solution does not exist or cannot be adequately created using conventional software methods. By means of example-based systems, it is possible to create and train a task on the basis of a set of examples. The learned task can be applied to a set of further examples.

In the dissertation “Quality Assured Efficient Development of Feedforward Artificial Neural Networks with Supervised Learning [Qualitätsgesicherte effiziente Entwicklung vorwärtsgerichteter künstilicher Neuronaler Netze mit überwachtem Lernen] (QUEEN)” by Thomas Waschulzik, the development of feedforward artificial neural networks with supervised learning is described (hereafter: WASCHULZIK).

Against this background, it is the object of the invention to improve the quality assurance of an example-based system.

According to the invention, this object is achieved by a method for quality assurance of an example-based system, in which the example-based system is created and trained on the basis of collected examples which form an example set. The respective example of the example set comprises an input value which lies in an input space. A first example set comprising a plurality of examples and a second example set comprising a plurality of examples are collected. A first quality rating (or quality indicator) which represents coverage of the input space by examples of the first example set is determined on the basis of the distribution of input values in the input space. A second quality rating (or quality indicator) which represents coverage of the input space by examples of the second example set is determined on the basis of the distribution of input values in the input space. The first quality rating and second quality rating are compared with one another.

On the one hand, the invention is based on the realization that example-based systems, such as neural networks, are often regarded as a black box. Here, the internal information processing is not analyzed and the generation of an understandable model is omitted. In addition, the system is not verified by inspection. This leads to reservations when using example-based systems in tasks with a high level of criticality.

The invention is also based on the realization that when examples are acquired to create and train the example-based system, it is often not known how many examples need to be collected in which areas of the input space to create a suitable knowledge base.

Another key finding of the invention is that examples for example-based systems are often acquired in several steps. In this iterative approach, it is desirable to ensure that no application-relevant differences occur between the acquisition of the first example set and the second example set, or that these differences can at least be detected and evaluated.

An example of a technical constellation in which differences between the first and second example set are relevant is the age-related change in properties of sensors that are used in the acquisition of the examples: ageing changes the calibration of the sensors and it has to be checked whether the first example set, which has been acquired in a first ageing level of the sensors, and the second example set, which has been acquired in a second ageing level of the sensors, still describe the same task.

Another example of different example sets is when one of the example sets has been deliberately falsified in order to harm the creator or user of the knowledge base.

The solution according to the invention remedies these problems by determining the first quality rating and the second quality rating and comparing both quality ratings. It may turn out, for example, that one of the example data sets must be discarded in whole or in part.

The respective quality rating represents the coverage of the input space by examples and is determined on the basis of the distribution of the input values in the input space. This provides a mapping of the input space. The mapping can be used as a basis for further acquisition of examples to create an appropriate knowledge base. Thus, the acquisition of examples can be controlled according to the distribution in the input space, although the specific type of classifier or approximator has not yet been defined. Also, the number of degrees of freedom with which the knowledge base is trained does not have to be defined yet. By knowing in which areas more examples need to be acquired, the examples can be acquired in a more targeted manner and consequently the cost of acquiring examples can be significantly reduced (since fewer examples need to be collected overall).

The invention also recognizes that a prerequisite for using input space mapping for example-based systems is a suitable representation and encoding of the characteristics. The raw data is transformed by application-specific transformations into a representation that is adapted to the solution of the task. This representation is transformed using standard procedures so that it can be used as the activity of the input neurons of a neural network (so-called encoding). Quality rating, which represents the coverage of the input space by examples of the example set, can be used at the level of representations and at the level of encodings.

The invention is further based on the realization that the encoding and/or representation of the input characteristics in the input space preferably have a semantic relationship with the desired output of the example-based system. Preferably, the mapping of the input space is to be performed when, for example, characteristics have been determined by pre-processing that have a semantic relationship to the outputs.

The invention is further based on the realization that the ratio between the number of independent input characteristics, which determine the dimension of the spanned state space, and the number of examples to be acquired for the configuration, training, evaluation and testing of the system is preferably not too large: this is because the coverage of the input space by examples is not sufficient in the case of a large ratio.

Further, the invention is based on the realization that the dimensions spanning the state space are preferably semantically independent of one another (i.e. represent independent aspects of the task). Further preferably, the dimensions are of equal relevance to the solution of the task.

Further preferably, only one classification task or approximation task is considered for quality assurance. For example, in an artificial neural network used as a single shot multibox detector (SSD), only the classification for a given object size in a so-called default box (i.e. with a pre-defined aspect ratio, with a pre-defined scale and at a given position in the image) is considered.

Preferably, the example-based system is intended for use in a safety-related function. The person skilled in the art understands the term “safety-related function” to mean a function of a system which is safety-relevant, i.e. the behavior of which has an influence on the safety of the surroundings of the system. In this context, the term “safety” is to be understood in the sense of so-called safety. In professional usage, “safety” refers to the objective of protecting the environment of a system from hazards that emanate from the system. In contrast, the objective of protecting the system from hazards that emanate from the environment of the system is referred to as “security” in technical language.

Another example of an application of the method according to the invention is a constellation in which the first example set has been subjected to quality assurance and the associated first quality rating is known. If the quality rating for the second example set corresponds or is similar, a satisfactory quality of the second example set can be assumed.

According to a preferred embodiment of the method according to the invention, a third example set is formed from the first and second example set and a third quality rating which represents a coverage of the input space by the examples of the third example set is determined on the basis of the distribution of the input values in the input space. The first quality rating, the second quality rating and the third quality rating are compared.

The third example set represents the union set, so to speak, of the first and second example set.

An example of the application of the third example set is a constellation in which the second example set is collected in the presence of knowledge that is gained on the basis of the first example set. For example, the second example set was collected in order to fill the gaps in the input space. The third example set can be used to determine whether the gaps have been successfully filled.

In a preferred embodiment of the method according to the invention, determining the quality rating comprises: distributing representatives in the input space and assigning a number of examples of the example set to the respective representative. The examples which are assigned to the representative are located in a surrounding area of the input space which surrounds the representative. As a first quality rating, a local quality rating for the surrounding area is determined on the basis of the examples of the first example set which are assigned to the representative. As a second quality rating, a local quality rating for the surrounding area is determined on the basis of the examples of the second example set which are assigned to the representative.

By assigning the examples from the example set to the representatives, example data sets are determined within the surrounding areas, which are assigned to the representatives. For each of these example data sets, the local quality ratings are calculated, i.e. the first quality rating and the second quality rating.

For example, it may be of interest to further investigate those surrounding areas in which the relative difference between the first quality rating and the second quality rating is comparatively large.

The subdivision of the example set into multiple surrounding areas brings with it the advantages that usually result from the approach of the divide-and-conquer method from computer science. For example, a developer of the example-based system can thus focus on those parts of the input space in which certain quality criteria are not fulfilled. In these parts, the quality can be checked accordingly and improved if necessary. This considerably reduces the effort involved in evaluating the entire example set.

As a representative, a representative example is preferably distributed. The distribution is preferably an equal distribution. In this case, for example, a grid is selected in the input space for the arrangement of the representative examples. The grid can be determined individually for each dimension of the input space. A criterion for determining the grid, for example in the case of categorical variables, can be a model regarding target properties of the example distribution in the input space, which is set on the basis of the requirements for the example-based system. The grid can be hierarchical, for example in order to represent hierarchical encodings. When using a grid to arrange the representative examples, one representative example is distributed in each hypercube in the input space of the grid. If the grid is hierarchical, one representative example is distributed per hierarchical level.

Alternatively, the representative is a center of a cluster, which is determined by means of a cluster procedure. Preferably, the cluster procedure is used to determine the position and to determine the extent of the respective cluster in the input space. Further preferably, the clustering procedure is performed under consideration of output values of the examples, which are located in an output space. The clusters can be determined on the basis of requirements for properties of the example-based system or on the basis of a subset of example data. For example, in the application of the example-based system, a set of examples which are selected on the basis of knowledge of how to fulfill the requirements can be collected at an early stage. This distribution of example data is then quality assured. In a subsequent phase of the project, more examples can be acquired with the same distribution. In this case, each example of the quality-assured example set represents a representative for the following phase of acquiring the examples. This ensures that an additional quality-assured set of examples is acquired for each initial example. The position of the representative can be determined, for example, by the cluster center. Alternatively, a hierarchical cluster procedure can be used in which one representative is inserted per cluster and per hierarchical level and in which each example per hierarchical level is assigned to a cluster and consequently to a representative. The set of examples available for the calculation of the quality rating is then assigned to the clusters and consequently to the representative via a predefined metric. For an example that cannot be assigned to a cluster, a new cluster with a representative is preferably created. Alternatively, this example is recorded separately by a quality rating together with other examples that could not be assigned to a cluster.

Further preferably, the examples are not fully assigned to a representative, but are only assigned to a predetermined proportion. This can result, for example, from using a cluster algorithm that provides a partial assignment of the examples to the example data sets (for example, a percentage assignment to multiple surrounding areas, in which the sum of the proportions results in 1). When determining the quality ratings on the basis of this partial assignment, the respective example is considered according to the associated proportion.

Preferably, the quality rating is determined on the basis of the number of examples which are assigned to the respective representative or on the basis of other characteristics. This is particularly advantageous if the specific examples are no longer used in the further process. A comparative variable for the comparison of the first and second quality rating can be the amount of the difference between the number of examples of the first example set, which is assigned to the representative, and the number of examples of the second example set which is assigned to the representative.

Alternatively or additionally, the specific examples or a reference to the examples are stored in the representative (transformation of the example data set into a structure that is oriented to the topography of the input space). This is advantageous if the specific examples are required in the further process.

The storage space required for processing is preferably reduced by storing the representatives only if there is at least one example in the respective surrounding area. When the coverage of the input space is determined, the surrounding areas in which no representative has been created are evaluated as “no example present”. Nevertheless, a histogram of the number of examples per representative can be created, since the number of surrounding areas in which no example has been recorded can be determined with little effort (sum of expected representatives−created representatives=number of fields without recorded examples).

In a preferred development, the third quality rating is a local quality rating for the surrounding area and is determined on the basis of the examples of the third set of examples which are assigned to the representative.

Preferably, the representatives are each distributed to the same positions in the input space when determining the first, second and/or third quality rating. In other words, the position of the representatives is preferably selected to be the same for all example sets. This makes it possible to assign the representatives of the first, second and/or third example set to one another.

According to a further preferred embodiment of the method according to the invention, the quality rating comprises a statistical means which is determined on the basis of the example set and/or the examples which are assigned to a respective representative.

In this manner, quality ratings can be made on the basis of the information that is assigned to the representatives, for example by means of descriptive statistics (as described in one of the following textbooks: “Statistics: The Way to Data Analysis [Statistik: Der Weg zur Datenanalyse]” (Springer textbook) Paperback—15 Sep. 2016 by Ludwig Fahrmeir (author), Christian Heumann (author), Rita Künstler (author), Iris Pigeot (author), Gerhard Tutz (author); “Statistics for Dummies” [Statistik fur Dummies] Paperback—4 Dec. 2019 by Deborah J. Rumsey (author), Beate Majetschak (translator), Reinhard Engel (translator); “ Workbook on descriptive and inductive statistics [Arbeitsbuch zur deskriptiven and induktiven Statistik]” (Springer-Text book) Paperback—27 Feb. 2009 by Helge Toutenburg (author), Michael Schomaker (contributor), Malte Wißmann (contributor), Christian Heumann (contributor)), can be defined.

The determined local quality ratings can be sorted and processed by means of a histogram. For example, the relative difference between the first quality rating (of the first example set) and the second quality rating (of the second example set) is determined for each surrounding area. On this basis, a histogram is created which is binned over the relative difference. The histogram representation further enables, for example, that by clicking on a respective bin, those surrounding areas are available for selection that have been assigned to the bin. One of the surrounding areas can then be selected and additional information, such as the distribution of the examples, can be displayed in detail.

According to a further preferred development, a statistical measure, in particular a mean, median, minimum, maximum and/or quantiles of the number of examples which are assigned to a representative, is determined as a statistical mean.

According to a further preferred development, neighboring surrounding areas are determined in the input space, the respective representative of which is assigned a number of examples which fulfills a predetermined quality criterion of the quality rating.

Preferably, the predetermined quality criterion is fulfilled if the number of examples which are assigned to a respective representative is below or exceeds a predetermined quality threshold or lies within a predetermined quality band of the quality rating.

When determining whether two surrounding areas are adjacent to one another, different neighborhood relations can be used, for example the Von Neumann neighborhood (also called 4-neighborhood), the Moore neighborhood (also called 8-neighborhood) or the neighborhood from graph theory. The defined neighborhood relations must be transferred accordingly for higher-dimensional spaces: for example, in the three-dimensional space, the 6-neighborhood is considered for cuboids with common faces, the 18-neighborhood for cuboids with common edges and the 26-neighborhood for cuboids with common vertices. The neighborhood is defined by the number of dimensions in which two grid points can differ in order to still be considered neighboring.

In a preferred development, a connection area which consists of adjacent surrounding areas is determined within the input space. The representatives of the surrounding areas are each assigned a number of examples. The number fulfills a predetermined quality criterion.

Preferably, the predetermined quality criterion is fulfilled if the number of examples which are assigned to a respective representative is below a predetermined quality threshold, exceeds it or lies within a predetermined quality band of the quality rating. Further preferably, additional examples are recorded in the respective surrounding area if the quality rating that is determined for the respective surrounding area is smaller than a predetermined quality threshold. Alternatively or additionally, examples are removed from a respective surrounding area if the quality rating that is determined for the respective surrounding area is greater than a predetermined quality threshold.

If the quality criterion is fulfilled by being below a predefined quality threshold, the location and size of areas of the input space in which too few examples have been collected can be determined in a particularly advantageous manner (“holes in the input space”, so to speak). In other words, a particular advantage of the embodiment is that partial areas of the input space are identified in which the example values do not provide a sufficient basis for a safety-critical application. This in turn has the advantage that corrective action can be taken, for example by acquiring further examples (for example as the second example set described above) or by restricting the knowledge base in the application to the connection areas of high quality.

In particular, identifying the areas in which too few examples have been acquired has the advantage that attacks by adversarial examples can be pre-emptively counteracted. This is because in these areas, the probability of success of an attack by an adversarial example is comparatively high. It can be reduced by acquiring further examples in these areas or by restricting the knowledge base to the connection areas of high quality.

Quality ratings can be calculated on the basis of the determined connection areas. For example, the number of representatives in a connection area can be determined. Histograms of the size or other properties of a connection area can be created. Furthermore, statistical measures such as a mean, median, quantiles or standard deviations of properties of the connection areas can be calculated. In addition, the extent of the connection areas in the dimensions of the input space can be determined. The dimensions can be ordered in the sequence of the largest extent of the connection area.

The determination of a connection area is of particular advantage in the example described above for the application of the third example set, in which the second example set is collected in the presence of knowledge gained from the first example set. In this example, the second example set was collected to fill in the gaps in the input space. These gaps can be identified and characterized on the basis of the connection areas described above. The third example set can be used to determine whether the gaps have been successfully closed.

According to a particularly preferred embodiment of the method according to the invention, the respective example comprises an output value which is located in an output space. For the respective surrounding area, a local complexity rating is determined which represents a complexity of a task of the example-based system, said complexity being defined by the examples of the surrounding area. The local complexity rating is determined by the relative position of the examples of the surrounding area with respect to one another in the input space and output space.

The person skilled in the art understands the phrase “relative position of the examples of the surrounding area with respect to one another in the input space and output space” to mean that the complexity rating is defined on the basis of the consideration of the similarity of the distances of the examples in the input space to the distances in the output space. For example, the task of the example-based system has a comparatively low complexity if the distances in the input space (apart from the scaling) roughly correspond to the distances in the output space.

This results in the advantage that examples can be collected effectively. This is because, on the basis of the complexity rating, areas are known in which a comparatively high number of examples must be collected due to the high complexity of the task of the example-based system. Preferably, in areas of the input space in which a higher complexity is present, the density of the representatives dynamically increases until a homogeneous complexity is achieved and a sufficient amount of examples are located in the surroundings of the representatives.

The complexity rating corresponds, for example, to the quality indicators described in section 4 (QUEEN quality indicators) by WASCHULZIK. These quality indicators can be defined and applied both for the representation or encoding of the characteristics (cf. section 4.5 by WASCHULZIK).

In a particularly preferred embodiment of the method according to the invention, a first complexity rating is determined for the examples of the first example set, a second complexity rating is determined for the examples of the second example set and a third quality rating is determined for the examples of the third example set. The third local complexity rating is compared to the first and/or second local complexity ratings.

Particular attention shall be paid to surrounding areas in which the third complexity rating indicates a significantly greater complexity of the third example set than the first and/or second complexity rating. In these surrounding areas, there is then either a problem in acquiring the examples or the first, second or both example sets have been falsified in order to harm the creator or user of the knowledge base. This application example is of particular importance because the high complexity cannot be detected on the basis of the first and second example set alone (but only on the basis of the third example set).

For the constellation described above, one action can be to remove examples from one of the two example sets and on the basis of the re-determined complexity rating determine whether an ‘improvement’ (i.e. reduced complexity) has been achieved. If an improvement is achieved, further examples can be removed. If there is a drift in the third complexity rating towards lower complexity, it is possible to advance in this manner.

An acceptance range or acceptance measure can be defined for handling the respective difference between the first, second and third complexity rating. In other words: if the agreement is within a certain range, the collected examples are accepted. The acceptance measure can be selected in dependence upon the size of the data set. For comparatively large data sets, the acceptance range is preferably selected to be narrower, and for comparatively small data sets, it is selected to be larger.

According to a further preferred embodiment of the method according to the invention, a complexity distribution is determined by means of a histogram representation of the complexity rating.

Preferably, the range of values of the complexity ratings is binned (i.e. divided into ranges) for the histogram representation.

In a preferred development, the complexity distribution over k-nearest neighbor of an example in the input space is determined. In this manner, how the complexity is distributed is determined for the local surroundings of an example. In particular, the characteristic of the complexity in the local surroundings of the example is determined and, so to speak, a fingerprint of the local surroundings of the example with respect to complexity is determined.

For example, the “binned” values are plotted on the y-axis and the representation of the increasing k (the k-nearest neighbor) is plotted on the x-axis.

To reduce the required computing capacity when determining the complexity distribution, the step size of the values of k>1 is selected. For example, with a step size of 5, a distribution of the complexity rating is determined for the values of k=5, 10, 15, 20, etc. Further preferably, the step size of k is selected to be small only in areas of particular interest. For example, the distribution of the complexity rating is first calculated with a comparatively large step size of k, in order then to be calculated with a small step size of k in a region of particular interest.

Further preferably, the number of values of the complexity rating is stored for the calculated histogram field (complexity rating binned, k). Further preferably, identification information (for example, a number) which represents the example in the vicinity of which the complexity distribution was determined is also stored.

According to a preferred embodiment of the method according to the invention, the integrated quality indicator QI² according to section 4.6 by WASCHULZIK is used as the quality indicator for the representations and said integrated quality indicator can be defined as follows on the basis of formula 4.21:

$${QI}^{2} ( P ) = \frac{1}{\vert {P}^{2} \vert} {\sum }_{{x}_{i} ∈ {P}^{2}} {( {d}_{NRE} ( {x}_{i} ) - {d}_{NRA} ( {x}_{i} ) )}^{2}$$

where, according to formula 4.18 by WASCHULZIK:

$${d}_{NRE} ( x ) = \frac{{d}_{RE} ( x )}{\frac{{\sum }_{y ∈ {P}^{2}} {d}_{RE} ( y )}{\vert {P}^{2} \vert}}$$

the normalized distance of the represented inputs (NRE) and

$${d}_{NRA} ( x ) = \frac{{d}_{RA} ( x )}{\frac{{\sum }_{y ∈ {P}^{2}} {d}_{RA} ( y )}{\vert {P}^{2} \vert}}$$

is the normalized distance of the represented outputs (NRA). Here, x is the pair (x₁, x₂, ) consisting of the two examples x₁ and x₂. x₁ and x₂ are examples from the example set P. P={p₁, p₁, . . . , p_{|P|}} is the number of elements of BAG P, wherein |P²| is the number of elements of BAG P. BAG is a multiset or bag as defined in the specification 21.5 on page 27 of the appendix by WASCHULZIK. The task QAG is defined in definition 3.1 on page 23 by WASCHULZIK and is called a QUEEN task.

d_{RE}(x) is an abbreviation for the distance in the input space dᵣₑ(νepₓ₁, νepₓ₂) and d_{RA}(x) is an abbreviation for the distance in the output space dᵣₐ(νapₓ₁, νapₓ₂).

The definition of the distance between the representation of two examples according to WASCHULZIK is based on the Euclidean norm. Thus, the distance in the input space is defined as (see formula 4.3 by WASCHULZIK):

$${d}_{re} ( {p}_{k 1} , {p}_{k 2} ) = \sqrt{{\sum }_{i = 1}^{aem} {( {vemp}_{i , k 1} - {vemp}_{i , k 2} )}^{2}}$$

with pₖ₁, pₖ₂ as examples of the quantity P, wherein

$${p}_{k} = ( {vep}_{k} , {vap}_{k} ) = ( \begin{matrix}( {vemp}_{1 , k} , {vemp}_{2 , k} , … , {vemp}_{QualityInputCharacteristics , k} ) , \\ ( {vamp}_{1 , k} , {vamp}_{2 , k} , … , {vemp}_{QualityOutputCharacteristics , k} )\end{matrix} )$$

with
i running index across all expressions;
vemp_{i,kx} expression of the input characteristic i of the example kx with kx ∈ R (R is the quantity of the real numbers); and
aem QuantityInputCharacteristics of the task QAG.

The person skilled in the art understands the wording “on the basis of the following definition” or “on the basis of formula 4.21 can be defined as follows” to mean that modifications and a function of the quality indicator F(QI2) are also encompassed by the idea of this definition.

In a preferred development, an aggregated complexity rating is determined by aggregating the local complexity ratings.

The aggregated complexity rating has the advantage that a developer of the example-based system can easily perform their quality assurance.

For example, as an aggregated complexity rating, a histogram is created of the complexity in the different surrounding areas of the input space. For this purpose, the range of values of the complexity ratings is binned (i.e. divided into ranges). Preferably, only the number of surrounding areas with corresponding complexity is binned when the positions of the surrounding areas are no longer needed. Preferably, this histogram is combined with information regarding the number of examples, for example also in a histogram regarding the number of examples which are assigned to the representative. Further preferably, information regarding the representatives is stored in the histogram so that it can be referred to in detailed analyses.

According to a further preferred development, the aggregated complexity rating is used to identify surrounding areas whose complexity rating is below a predefined complexity threshold. In the determined surrounding areas, the task of the example-based system is implemented by an algorithmic solution. This is particularly advantageous for applications with high quality requirements, for example for safety-related functions.

This preferred development is based on the realization that the exact functioning of the system (i.e. semantic relationships) is often known for areas with low complexity of the task. In this case, the task can be implemented as a conventional algorithm (rather than as an example-based system). This is particularly advantageous because sufficient safety of the safety-related function is usually easier to prove within the scope of an approval procedure for the simple algorithmic solution.

This development also has the advantage that no further examples need to be acquired in the areas of low complexity.

Preferably, when searching for simple areas, data collection artifacts are also searched for, which result in a relationship between input and output, which are given by special circumstances of the data collection, but do not represent a relationship that can be used in practice (as known, for example, from the so-called Kluger-Hans effect: https://de.wikipedia.org/wiki/Kluger_Hans). In areas of particularly high complexity, the examples are analyzed to see whether, for example, problems have occurred in the collection and recording of the examples.

According to a further preferred embodiment of the method according to the invention, the input space is divided hierarchically on the basis of the quality rating.

Preferably, a hierarchical mapping of the input space is achieved by the hierarchical subdivision of the input space. The hierarchy is further preferably derived from the representation or encoding of the input characteristic and/or from the analysis of the complexity of the task.

On the basis of the introduction of an additional hierarchy in the analysis of the input space, either the density of representatives can be dynamically increased (until a homogeneous complexity is achieved) or a new hierarchy level can be introduced in the areas in which a high complexity is present. The introduction of a new hierarchy level is performed by adding a new subdivision with a higher resolution in the area of the representative. The procedure can be iterated by adding another hierarchy level in the high-resolution area when local complexity is increased again. In this manner, the resolution can be dynamically adapted to the respective task.

According to a further preferred embodiment of the method according to the invention, the example-based system is provided for use in a safety-related function, wherein the safety-related function includes object recognition on the basis of an image recognition, in which the object is recognized using the example-based system.

In a preferred embodiment, the object recognition is used in an automated operation of a vehicle, in particular a track-bound vehicle, a motor vehicle, an aircraft, a watercraft and/or a spacecraft.

Object recognition during automated operation of a vehicle is a particularly expedient implementation of a safety-related function. Object recognition is required, for example, to detect obstacles in the path of travel or to analyses traffic situations with regard to the right of way of road users.

The motor vehicle is, for example, a motor vehicle, for example a passenger car, a lorry or a tracked vehicle.

The watercraft is, for example, a ship or submarine.

The vehicle can be manned or unmanned.

An example of an application area is the autonomous or automated driving of a track-bound vehicle. In order to achieve the object, object recognition systems are used to analyses scenes that are digitized using sensors. This scene analysis is required, for example, to detect obstacles on the path of travel or to analyze traffic situations with regard to the right of way of road users. For the recognition of objects, systems that are based on the use of examples with which parameters of the pattern recognition system are trained are currently being used particularly successfully. Examples of this are neural networks, for example using deep learning algorithms.

According to another preferred embodiment of the method according to the invention, the example-based system is intended for use in a safety-related function, wherein the safety-related function comprises a classification on the basis of sensor data of organisms.

Tissue classification of animal or human tissue is a particularly useful implementation of a safety-related function in the field of medical imaging. The organisms include, for example, Archaea (primordial bacteria), Bacteria (true bacteria) and Eukarya (nucleated) or of tissues of Protista (also Protoctista, founders), Plantae (plants), Fungi (fungi, chitinous fungi) and Animalia (animals).

Further areas of application are the safe control of industrial plants (for example synthesis in chemistry, the control of production processes, for example rolling mills), a classification of chemical substances (for example environmental toxins, warfare agents), a classification of signatures of vehicles (for example radar or ultrasonic signatures) and/or a control in the field of industrial automation (for example production of machines).

According to a further preferred embodiment of the method according to the invention, the example-based system comprises:
a system with supervised learning,
a system constructed using statistical methods,
preferably an artificial neural network with one or more layers of neurons other than input neurons or output neurons, trained with back-propagation,
in particular a convolutional neural network,
in particular a single-shot multibox detector network.

The use of artificial neural networks often enables an improvement in classification or approximation performance.

The one or more layers of neurons that are not input neurons or output neurons are often referred to in technical terms as hidden neurons. Training neural networks with many layers of hidden neurons is often referred to in technical terms as deep learning. A special type of deep learning networks for pattern recognition are the so-called convolutional neuronal networks (CNNs). A special case of CNNs are the so-called SSD networks (single shot multibox detector networks). The person skilled in the art understands the term “single shot multibox detector” as a method for object recognition according to the deep learning approach, which is based on a convolutional neural network and is described in: Liu, Wei (October 2016). SSD: Single shot multibox detector. European Conference on Computer Vision. Lecture Notes in Computer Science. 9905. 16 pp. 21-37. arXiv:1512.02325.

The invention further relates to a computer program comprising instructions which, when the program is executed by a computing unit, cause the computing unit to perform the method of the type described above.

The invention further relates to a computer-readable storage medium comprising commands which, when executed by a computing unit, cause the computing unit to perform the method of the type described above.

For advantages, embodiments and implementation details of the features of the computer program and computer-readable storage medium according to the invention, reference can be made to the above description concerning the corresponding features of the method according to the invention.

An exemplary embodiment of the invention will be explained with reference to the drawings. In the drawings:

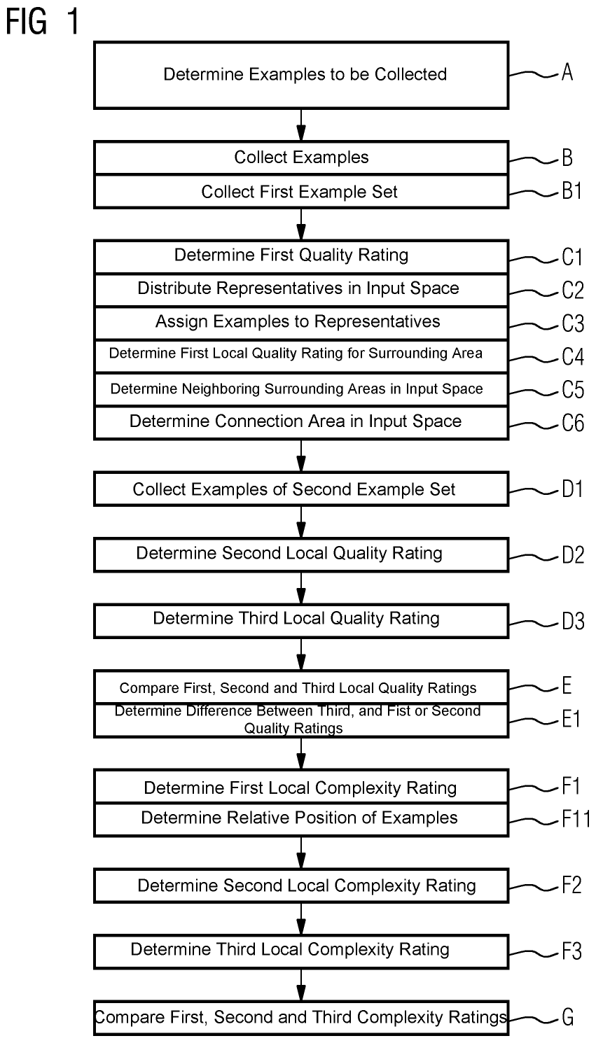

FIG. 1 schematically shows the sequence of an exemplary embodiment of a method according to the invention,

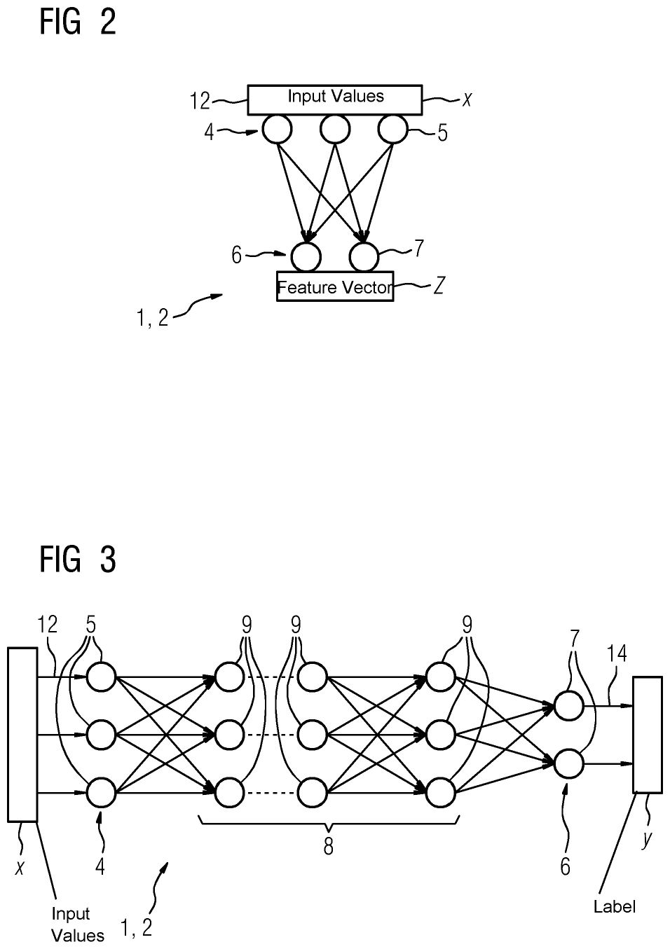

FIG. 2 schematically shows the structure of an example-based system with unsupervised learning,

FIG. 3 schematically shows the structure of an example-based system with supervised learning according to the exemplary embodiment of the method according to the invention,

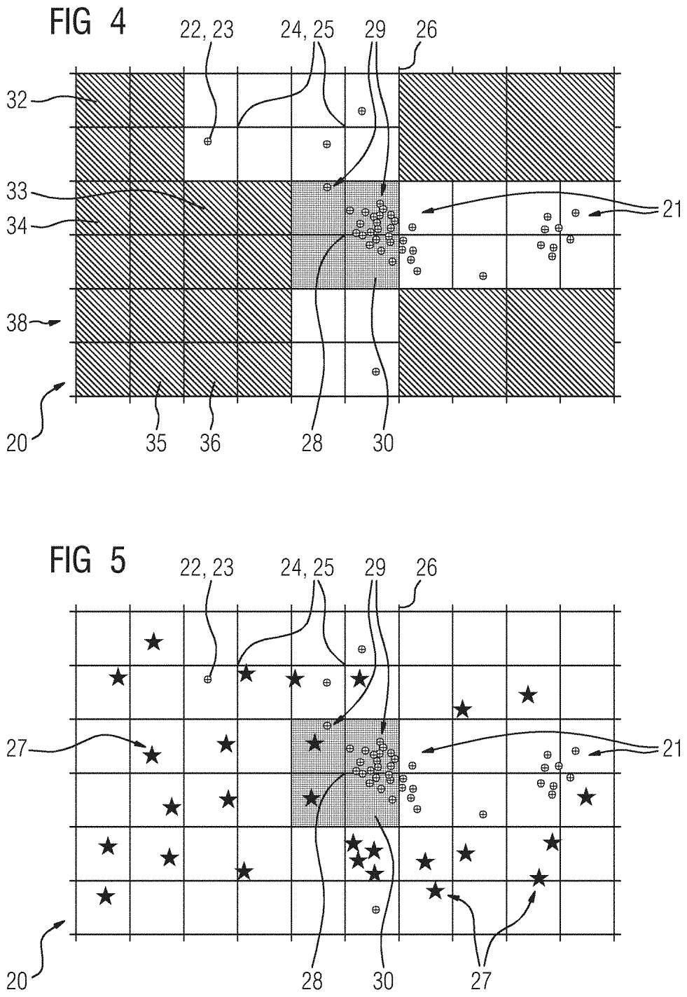

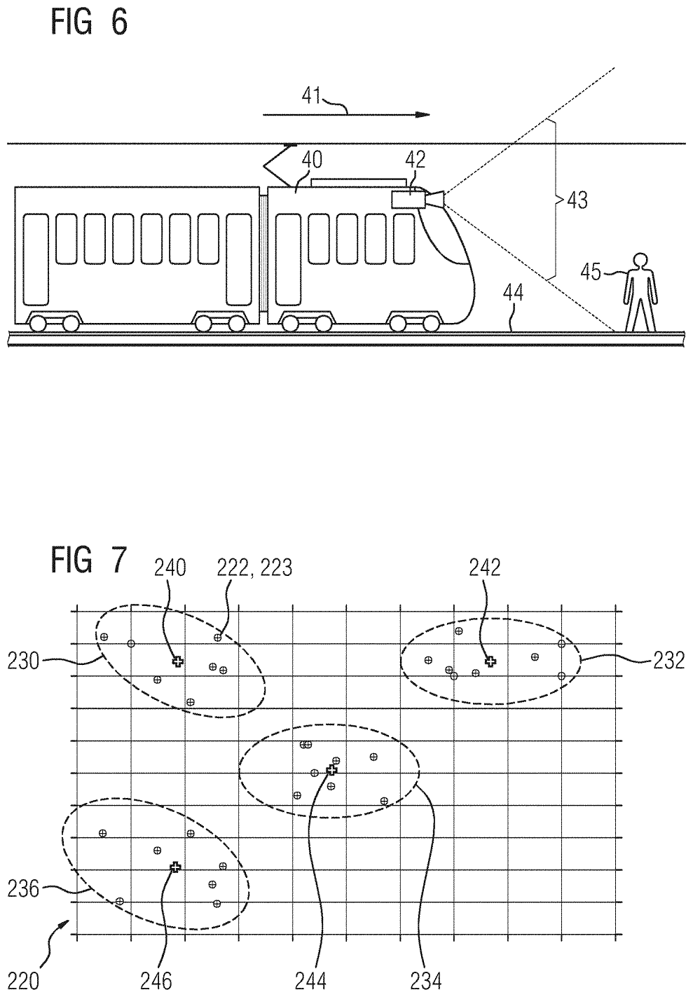

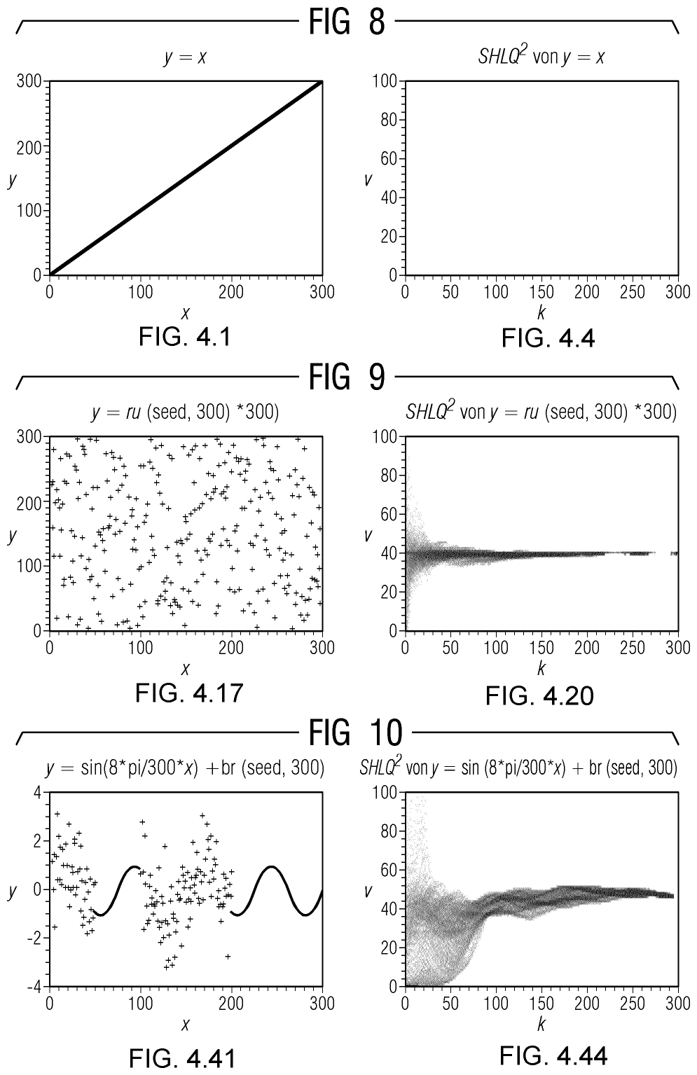

FIG. 4 schematically shows a two-dimensional input space according to the exemplary embodiment of the method according to the invention,

FIG. 5 schematically shows the two-dimensional input space shown in FIG. 4 in a second state,

FIG. 6 shows a schematic side view of a track-bound vehicle located on a travel path,

FIG. 7 schematically shows a further example of a two-dimensional input space according to a further exemplary embodiment of the method according to the invention,

FIG. 8 shows two axis diagrams which represent the application of the complexity rating on a first synthetic function,

FIG. 9 shows two axis diagrams which represent the application of the complexity rating on a second synthetic function, and

FIG. 10 shows two axis diagrams which represent the application of the complexity rating on a third synthetic function.

FIG. 1 shows a schematic flowchart which represents the sequence of an exemplary embodiment of a method according to the invention for quality assurance of an example-based system. The method can be applied to example-based systems with supervised and unsupervised learning.

In supervised learning, the objective is to learn a function that maps data x (as input values) onto a label y. An example of supervised learning is classification, where, for example, image data x is mapped onto a class y (for example cat). Other examples of supervised learning are regression, object recognition, image labeling, etc.

In unsupervised learning, the objective is to learn a structure of data x (without using a label y). An example of unsupervised learning is clustering, which aims to find groups within the data that have similarities in a certain metric. Other examples of unsupervised learning include dimensionality reduction or the learning of characteristics (so-called feature learning or representation learning), etc.

FIGS. 2 and 3 show exemplary embodiments of example-based systems 1. FIG. 2 schematically shows the structure of an exemplary embodiment of an example-based system 1, which is implemented as an auto-encoder. Auto-encoders are a type of artificial neural network 2 that can be used for efficient data encoding and learn this ability in an unsupervised manner. The auto-encoder maps the input values x to a feature vector Z.

FIG. 3 schematically shows the structure of an exemplary embodiment of an example-based system 1 with supervised learning, which is designed as a multilayer perceptron. Further examples of systems with supervised learning can be a recurrent neural network, a convolutional neural network or, in particular, a so-called single-shot multibox detector network.

The example-based system 1 is formed by an artificial neural network 2 which has a layer 4 of input neurons 5 and a layer 6 of output neurons 7.

The artificial neural network 2 shown in FIG. 3 has a plurality of layers 8 of neurons 9 that are not input neurons 5 or output neurons 7.

The example-based system and the method according to the invention are implemented by means of one or more computer programs. The computer program comprises commands which, when the program is executed by a computing unit, cause the computing unit to perform the method according to the invention according to the exemplary embodiment shown in FIG. 1. The computer program is stored on a computer-readable storage medium.

The example-based system is used in a safety-related function of a system. The behavior of the function thus has an influence on the safety of the surroundings of the system. An example of a safety-related function is object recognition on the basis of image recognition, in which the object is recognized using the example-based system 1 (with supervised learning). The object recognition is used, for example, in an automated operation of a vehicle, in particular of a track-bound vehicle 40 shown in FIG. 4, a motor vehicle, an aircraft, a watercraft or a spacecraft.

Another example of a safety-related function is a classification on the basis of sensor data of organisms for example of Archaea (primordial bacteria), Bacteria (true bacteria) and Eukarya (nucleated) or of tissues of Protista (also Protoctista, founder), Plantae (plants), Fungi (fungi, chitinous fungi) and Animalia (animals), a safe control of industrial plants, a classification of chemical substances, a classification of signatures of vehicles or a control in the field of industrial automation.

In a procedural step A, it is determined which examples are to be collected. In step B, the examples are collected: The collected examples form an example set. The respective example has an input value 12, which lies in an input space, and an output value 14, which lies in an output space. In the case of object recognition (as one of several possible examples of a safety-related function with supervised learning) for an automated operation of the track-bound vehicle 40 shown in FIG. 6, the examples are collected by providing the track-bound vehicle 40 with a camera unit 42 for capturing images. The camera unit 42 is oriented in the direction of travel 41 in such a manner that a spatial area 43 ahead in the direction of travel 41 is captured by the camera unit. The track-bound vehicle 40 travels with the camera unit 42 in the direction of travel 41 along a travel path 44. Scenes relevant to the creation and training of the example-based system 1 for object recognition are simulated for the acquisition of examples. For example, cardboard figures, crash test dummies or actors 45 are used to represent persons on the travel path 44 who are to be recognized by means of the example-based system 1 that is to be created and trained. Alternatively, scenes can be recreated by means of a so-called virtual reality.

FIG. 4 shows an example of a two-dimensional input space 20. In the actual application of the method according to the invention, the input space and output space will often have a higher dimensionality.

According to the method according to the invention, in a method step B1 a first example set 21 comprising a plurality of examples 22 is collected. The examples 22 of the example set 21 are shown as crosshairs 23 in FIG. 4.

In a method step C1, a first quality rating which represents a coverage of the input space by examples of the first example set 21 is determined. In determining C1 the quality rating, representatives are distributed in the input space in a method step C2. The representatives 24 are equally distributed and are represented as cross points 25 of the grid 26 shown.

In a method step C3, a number of examples 29 of the example set are assigned to a respective representative 28. The examples 29 which are assigned to the representative 28 are located in a surrounding area 30 of the input space 20, which surrounds the respective representative 28. he surrounding area 30 is shown as an example in FIG. 4 as a dotted area. In a method step C4, a first local quality rating for the surrounding area 30 is determined as the quality rating. The local quality rating is also determined for each further surrounding areas shown in FIG. 4.

In a method step C5, neighboring surrounding areas 32-36 are determined in the input space, the respective representative of which is assigned a number of examples that is below a predefined quality threshold. In FIG. 4, these neighboring areas 32-36 are shown as areas with diagonal stripes. In the example shown in FIG. 4, the surrounding areas 32-36 are areas in which no example is located. In addition, in a method step C6, a connection area 38 is determined within the input space 20, which consists of the neighboring surrounding areas 32-36, the representatives of which are each assigned a number of examples that is below a predetermined quality threshold. This determines the location and size of areas of the input space 20 in which too few examples have been recorded. In other words, sub-areas of input space 20 are identified in which the example values do not provide a sufficient basis for a safety-critical application.

Corrective action can be taken on the basis of the identification: for this purpose, for example, examples of a second example set 27 are collected in a further process step D1 and the knowledge regarding the first example set is taken into account during the collection. The examples of the second example set 27 are shown as stars in FIG. 5.

Corresponding to the determination of the first local quality rating, a second local quality rating is determined for each of the surrounding areas in a method step D2.

The first and second example set together form a third example set as a union set. In a method step D3, a third local quality rating is determined for each of the surrounding areas, said third local quality rating representing the coverage of the input space by the examples of the third example set.

The first, second and third quality rating are compared in a method step E. For example, a difference between the third quality rating and the first or second quality rating is determined in a method step E1. If the quality of the example set has improved in the union set compared to the first example set 21, an improvement in the knowledge base can be assumed by collecting the second example set 27.

For example, the quality rating can be determined on the basis of the number of examples which are assigned to the respective representative. A comparator for comparing the first and second quality rating can be the amount of difference between the number of examples of the first example set which are assigned to the representative and the number of examples of the second example set which are assigned to the representative.

In a method step F1, a first local complexity rating is determined for the respective surrounding area and said local complexity rating represents a complexity of a task of the example-based system defined by the first example set 22 of the surrounding area. Thereby, the local complexity rating is determined according to a method step F11 by the relative position of the examples of the surrounding area to one another in the input space 20 and the output space. In other words, the complexity rating is defined on the basis of considering the similarity of the distances of the examples in the input space 20 to the distances in the output space. For example, the task of the example-based system has a comparatively low complexity if the distances in the input space 20 (apart from scaling) are approximately the same as the distances in the output space. The complexity rating is used to determine areas in which a comparatively high number of examples must be acquired due to the high complexity of the task of the example-based system. For example, in areas of the input space 20 in which a higher complexity is present, the density of representatives is dynamically increased until homogeneous complexity is achieved.

The complexity rating corresponds to the quality indicators described in section 4 (QUEEN quality indicators) by WASCHULZIK. These quality indicators can be defined and applied both for the representation or encoding of the characteristics (cf. section 4.5 by WASCHULZIK). An example of this quality indicator for the representations is the integrated quality indicator QI² according to section 4.6 by WASCHULZIK.

In a method step F2, a second local complexity rating which represents the complexity of a task of the example-based system that is defined by the second example set is determined for the respective surrounding area. A third local complexity rating is determined for the examples of the third example set (union set) in a method step F3.

In a method step G, the first, second and third complexity rating are compared. Particular attention is to be paid to surrounding areas in which the third local complexity rating indicates a significantly greater complexity of the third example set than the first and/or second complexity rating. In these surrounding areas, there is then either a problem in the acquisition of the examples or the first, second or both example sets 21 and 27 have been falsified in order to harm the creator or user of the knowledge base. This application example is of particular importance because high complexity cannot be detected on the basis of the first and second example sets 21 and 27 alone (but is detectable on the basis of the third example set alone).

As an alternative to the exemplary embodiment described with reference to FIGS. 4 and 5, according to which representatives are equally distributed in the input space, FIG. 7 shows an exemplary embodiment of an input space 220 in which the representatives each form a center of a cluster that is determined by means of a cluster method. The examples 222 of the example set are shown in FIG. 7 as crosshairs 223.

FIG. 7 shows four exemplary clusters 230, 232, 234 and 236, each comprising multiple examples. These examples are shown to lie within a dashed boundary line, which does not represent an actual boundary of a cluster, but was drawn for illustrative purposes only. Clusters 230, 232, 234 and 236 each have an associated cluster center 240, 242, 244 and 246 (shown in a plus shape). The cluster centers 240, 242, 244, 246 each lie centrally within the cluster and are assigned to a cluster independently of the boundaries of the grid of the input space.

The clusters according to FIG. 7 have the advantage that they represent the topology of the data in a particularly suitable manner. The grid according to FIGS. 4 and 5 has the advantage that the uncovered areas are mapped more appropriately. For example, the coverage of the input space (according to method step C1-C6) can be calculated via the grid and the complexity rating (according to method step F1-F3) can also be calculated via the cluster center in addition to the grid. Which approach is more suitable can also depend on the neural network procedure. If the encoding neurons can move in the input space, then the cluster approach is preferably selected or the cluster centers are equated with the positions of the encoding neurons in the input space.

In order to gain an understanding of the properties and behavior of the quality indicators described in WASCHULZIK as examples of a complexity rating, it is helpful to apply them to synthetic functions (for example y=x). It is possible to conclude from this how these quality indicators can be used in example-based systems.

The FIGS. 8 to 10 each show, for a synthetic function, a histogram of the distribution of complexity ratings over k-nearest neighbors of a preselected example. The example is, for example, a representative example or a center of a cluster (as described above). Furthermore, the example can be an example that is selected from the surrounding area of a representative example, said example having been selected for a more in-depth investigation with respect to the complexity of the task.

FIG. 8 shows on the left the FIG. 4.1 and on the right the FIG. 4.4 by WASCHULZIK. As a synthetic function, FIG. 8 shows y=x as an axis diagram on the left (the entries in the axis diagram are shown as “+”). The axis diagram on the right shows a histogram SHLQ² of QI² over the k-nearest neighbors of an example for the function y=x. It can be seen that for any local surroundings k of an example, the histogram SHLQ² shown has the value zero.

FIG. 9 shows the FIG. 4.17 on the left and on the right FIG. 4.20 by WASCHULZIK. As a synthetic function, FIG. 9 shows y=ru(seed, 300)*300 as an axis diagram on the left. It is an equally distributed random variable with values between 0 and 300. The axis diagram on the right shows the histogram SHLQ² of QI² over the k-nearest neighbors of an example of the function y=ru(seed, 300)*300. The axis diagram in FIG. 9 on the right is scaled so that 40 stands for the value 1.

FIG. 10 shows FIG. 4.41 on the left and on the right FIG. 4.44 by WASCHULZIK. As a synthetic function, y=sin(8*pi*x/300)+br(seed, 300) is shown as an axis diagram in FIG. 10 on the left. It is a sinusoidal function that has stochastic noise in the ranges 0<x≤50 as well as 100<x≤200. The axis diagram on the right shows the histogram SHLQ² of QI² over the k-nearest neighbors of an example of the function y=sin(8*pi*x/300)+br(seed, 300). The axis diagram in FIG. 10 is scaled such that 40 represents the value 1. The person skilled person in the art recognizes from this representation that there are multiple k-neighborhoods up to the size of approx. 45, in which the value of QI² is almost 0 (recognizable from the dark grey shading of the bins with small numbers plotted on the V-axis) and thus there is an almost linear mapping of the input and output space. If the person skilled in the art now analyses, by reading out the information in the histogram, in the surroundings of which examples the low complexity is present, they obtain the example with x=75 in whose vicinity k=45 the complexity is very low. The same applies to x=225 or x=275 for k=45. Thus, without any prior knowledge of how the examples are distributed in the input space, the person skilled in the art can easily, quickly and reliably identify the areas in which the complexity is particularly low or high. By reading out the bins with the high values even in large surroundings, the person skilled in the art can identify areas with high complexity (for example bin number 80 for K=20). This identification of areas of high or low complexity can be performed independently of the dimension of the input and output space, since the distance of the k-nearest neighbors can be determined in spaces of any dimensionality. Using the same procedure, the person skilled in the art can also identify the representatives from the histograms via the size of the connection areas, in which, for example, very few examples are contained. The representative can then be used to determine the position in the input space in which further examples must be recorded.

Although the invention has been illustrated and described in more detail by the preferred exemplary embodiment, the invention is not limited by the disclosed examples and other variations can be derived therefrom by those skilled in the art without departing from the scope of protection of the invention.

1-19. (canceled)

20. A method for quality assurance of an example-based system, the method comprising:
creating and training the example-based system based on collected examples forming an example set;
a respective example of the example set including an input value lying in an input space;
collecting a first example set including a plurality of examples and a second example set including a plurality of examples;
determining a first quality rating representing coverage of the input space by the examples of the first example set based on a distribution of input values in the input space;
determining a second quality rating representing coverage of the input space by the examples of the second example set based on the distribution of input values in the input space; and
comparing the first quality rating and the second quality rating with one another.

21. The method according to claim 20, which further comprises:
forming a third example set from the first and second example sets; and
determining a third quality rating representing a coverage of the input space by examples of the third example set based on the distribution of the input values in the input space; and
comparing the first quality rating, the second quality rating and the third quality rating.

22. The method according to claim 21, which further comprises:
carrying out the determination of the quality rating by:
distributing representatives in the input space, and
assigning a plurality of examples of the example set to a respective representative;
locating the examples assigned to the representative in a surrounding area of the input space surrounding the representative; and
at least one of:
determining, as a first quality rating, a local quality rating for the surrounding area based on the examples of the first example set assigned to the representative, or
determining, as a second quality rating, a local quality rating for the surrounding area based on the examples of the second example set assigned to the representative.

23. The method according to claim 22, which further comprises providing the third quality rating as a local quality rating for the surrounding area and determining the third quality rating based on the examples of the third example set assigned to the representative.

24. The method according to claim 22, which further comprises providing the quality rating with at least one of statistical measures determined based on the set of examples or examples assigned to a respective representative.

25. The method according to claim 24, which further comprises determining as a statistical mean at least one of a statistical measure, a mean, a median, a minimum or quantiles of the plurality of examples assigned to a representative.

26. The method according to claim 22, which further comprises determining adjacent surrounding areas in the input space having a respective representative assigned a plurality of examples fulfilling a predetermined quality criterion of the quality rating.

27. The method according to claim 26, which further comprises determining a connection area formed of adjacent surrounding areas within the input space and assigning each representative of the surrounding areas a number of examples fulfilling a predetermined quality criterion of the quality rating.

28. The method according to claim 22, which further comprises:
providing the respective example with an output value located in an output space;
determining for the respective surrounding area a local complexity rating representing a complexity of a task of the example-based system, the complexity being defined by the examples of the surrounding area; and
determining the local complexity rating by a relative position of the examples of the surrounding area with respect to one another in the input space and the output space.

29. The method according to claim 28, which further comprises:
determining a first local complexity rating for the examples of the first example set, determining a second local complexity rating for the examples of the second example set and determining a third local complexity rating for the examples of the third example set; and
comparing the third local complexity rating with at least one of the first or second local complexity rating.

30. The method according to claim 28, which further comprises a complexity distribution is determined by using a histogram representation of the complexity rating.

31. The method according to claim 30, which further comprises determining a complexity distribution over k-nearest neighbors of an example in the input space.

32. The method according to claim 28, which further comprises:
providing the complexity rating as an integrated quality indicator QI²;
determining the integrated quality indicator based on a definition as follows:
$${QI}^{2} ( P ) = \frac{1}{\vert {P}^{2} \vert} {\sum }_{{x}_{i} ∈ {P}^{2}} {( {d}_{NRE} ( {x}_{i} ) - {d}_{NRA} ( {x}_{i} ) )}^{2}$$
wherein:
$${d}_{NRE} ( x ) = \frac{{d}_{R E} ( x )}{\frac{{\sum }_{y ∈ {P}^{2}} {d}_{R E} ( y )}{\vert {P}^{2} \vert}}$$
is a normalized distance of the represented inputs and
$${d}_{NRA} ( x ) = \frac{{d}_{R A} ( x )}{\frac{{\sum }_{y ∈ {P}^{2}} {d}_{R A} ( y )}{\vert {P}^{2} \vert}}$$
is a normalized distance of the represented outputs,
wherein x is a pair (x₁, x₂, ) formed two examples x₁ and x₂,
wherein x₁ and x₂ are examples from an example set P,
wherein {p₁, p₁, . . . , p_{|P|}} is a number of elements of a multiset BAG P, and
wherein |P²| is a number of elements of the multiset BAG P.

33. The method according to claim 20, which further comprises providing the example-based system for use in a safety-related function and providing the safety-related function with object recognition based on an image recognition, in which the object is recognized by using the example-based system.

34. The method according to claim 33, which further comprises using the object recognition in an automated operation of at least one of a vehicle or a track-bound vehicle, or a motor vehicle, or an aircraft, or a watercraft or a spacecraft.

35. The method according to claim 20, which further comprises providing the example-based system for use in a safety-related function and using the safety-related function to represent a classification based on sensor data of organisms or a safe control of industrial plants, including a classification of chemical substances, a classification of signatures of vehicles or a control in a field of industrial automation.

36. The method according to claim 20, which further comprises providing the example-based system with:
a system with supervised learning,
or an artificial neural network with one or more layers of neurons not being input neurons or output neurons and being trained with back-propagation,
or a convolutional neural network,
or a single-shot multibox detector network.

37. A computer program stored on a non-transitory computer-readable storage medium, the computer program comprising commands which, when the program is executed by a computing unit, cause the computing unit to perform the method according to claim 20.

38. A non-transitory computer-readable storage medium, comprising commands which, when executed by a computing unit, cause the computing unit to perform the method according to claim 20.
